(19) United States
(12) Patent Application Publication
(10) Pub. No.: US 2007/0109143 A1
(43) Pub. Date: May 17, 2007

(54) Method for determining the state of a field measuring instrument for process automation and process instrumentation, and field measuring instrument for carrying out the method

(75) Inventors: Peter Klofer, Steinen (DE); Herbert Schroth, Schopfheim (DE)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co. KG, Maulburg (DE)

(21) Appl. No.: 10/536,454

(22) PCT Filed: Nov. 25, 2003
(86) PCT No.: PCT/EP03/13230

§ 371 Date: Mar. 27, 2006

(30) Foreign Application Priority Data
Nov. 26, 2002 (DE) 102 55 288.6

(51) Int. Cl. G08B 21/00

(52) U.S. Cl. 340/665; 340/540

(57) ABSTRACT

In order systematically to register individual, or a combination of, adverse influences on, and in order to be able better to estimate, service life or ability of a measuring field-device to function, at least one relevant influencing variable, preferably, however, a plurality thereof, is/are evaluated. In such case, Oin addition to a measured value [[(24)]] for a process variable, further variables [[(25) and (26)]] are registered by corresponding sensors mounted on, or in, the measuring field-device and conditioned in analog format in suitable operating circuits, preparatory to registering them digitally with the same A/D-converter [[(21)]] that registers the measurement signal [[A]] for the process variable. Multiplexer [[(22)]] permits selection of the desired input signal, which is then processed further with the aid of a microprocessor [[(23)]]. Then, the combined effect of the different influencing variables is determined and a remaining, probable service life calculated. In case the influencing variables [[(25, 26)]] assume critical values, the microprocessor [[(23)]] can trigger an alarm signal.

The invention relates to a method for determining the state of a measuring field-device for process automation and process measurement technology for registering at least one process variable of a process medium, and also relates to a measuring field-device for performing such a method.

Measuring field-devices for process automation and process measurement technology are known per se. They serve to monitor and control industrial manufacturing and treatment processes, and are applied for registering process variables, such as e.g. pressure, temperature, fill level of a process medium in a container, or flow rate.

Measuring field-devices are, in such case, frequently subjected to adverse environmental and, as the case may be, process influences, which can lead to a reduction of their service life or a limiting of their ability to function. It is known, in such case, to evaluate measured values delivered by a measuring field-device for possible errors caused by the adverse influences and to make corrections, as required. A measuring field-device of such type is described, for example, in European Patent EP-0 646 234-B1. Service life, or ability of the measuring field-device, as a whole, or as regards its parts, or modules, to function under the influence of individual ones, or combinations, of the described adverse influences, has, however, not yet been systematically investigated.

An object of the invention, therefore, is to provide a method, and a measuring field-device, wherein, by the registering of at least one relevant influencing variable, a statement can be made concerning the ability of the measuring field-device to function or concerning its expected, remaining service life.

This object is achieved by a method for determining the state of a measuring field-device for process automation and process measurement technology for registering at least one process variable of a process medium, which method is characterized by the following method steps:

a) Registering at least one influencing variable influencing expected service life of the measuring field-device, or ability of the measuring field-device to function, wherein the influencing variable is not the process variable;

b) comparing the measured influencing variable with an earlier determined, maximum or minimum, allowable value for this influencing variable; and

c) generating and issuing an alarm signal in the case of exceeding the maximum allowable value, or in the case of subceeding, or falling beneath, the minimum allowable value, of the influencing variable.

The above described object is also achieved by a measuring field-device for process automation and process measurement technology and for registering at least one process variable of a process medium, which measuring field-device includes a measuring device housing having an electronics accommodated therein, characterized in that the measuring field-device further includes
a mechanism for registering an influencing variable influencing expected service life, or ability of the measuring field-device, or a part, or module thereof, to function, wherein the influencing variable is not the process variable,
a mechanism for comparing the measured influencing variable with an earlier determined, maximum, or minimum, allowable value for this influencing variable, and
a mechanism for generating and issuing an alarm signal in the case of exceeding the maximum allowable value or in the case of subceeding, or falling beneath, the minimum allowable value, of the influencing variable.

A special advantage of this method, or of this measuring field-device, lies in the feature that diagnosis, alarm and other signals are provided, which warn, in time, before the reaching of critical values of the influencing variables regarding service life of the measuring field-device, or ability of the measuring field-device to function.

The above-described object is also achieved by a method for determining the state of a measuring field-device for industrial process automation and process measurement technology for registering at least one process variable of a process medium, which method is characterized by the following method steps:

a) registering at least one influencing variable influencing expected service life, or ability of the measuring field-device to function, wherein the influencing variable is not the process variable;

b) determining probable service life of the measuring field-device, or remaining period of time until the reaching of a point in time for maintenance work, by means of a predetermined function and on the basis of the currently registered, influencing variable;

c) producing and issuing a reporting signal, which reflects the probable service life of the measuring field-device, or the remaining period of time until the reaching of the point in time for maintenance work.

The above-described object is, moreover, achieved by a measuring field-device for industrial process automation and process measurement technology and for the registering of at least one process variable of a process medium, which measuring field-device includes a measuring device housing with an electronics accommodated therein, characterized in that the measuring field-device further includes
a mechanism for registering an influencing variable influencing expected service life of the measuring field-device, or of a part, or module thereof, wherein the influencing variable is not the process variable,
a mechanism for determining probable service life, or remaining period of time until the reaching of a point in time for maintenance work on the measuring field-device or, on a part, or module thereof, by means of a predetermined function and on the basis of the currently registered, influencing variable, and
a mechanism for producing and issuing a reporting signal, which reflects the probable service life, or the remaining period of time until the reaching of a point in time for maintenance work on the measuring field-device, or on a part, or module thereof.

A special advantage of this method, or of this measuring field-device, of the invention resides in the feature that, in contrast to an error diagnosis after occurrence of the error in the measuring field-device, perhaps by a self-test of the field device, the registering of relevant variables enables a predictive maintenance.

Influencing variables, which determine service life and ability of the measuring field-device, or individual ones of its parts or modules, to function are, for example, temperature, moisture in the device, infiltrated gases, vibrations, and forces. Accordingly, some preferred forms of embodiment of the invention claimed in the dependent claims are concerned with the registering and considering of these influencing variables.

Beyond this, other preferred forms of embodiment of the invention provide that a plurality of the influencing variables influencing service life and ability of the measuring field-device to function are registered and that their combined influence is considered. In further embodiments of the invention, stored values of the registered influencing variables are taken into consideration for determining the remaining, probable service life. For example, the stored values are subjected to a trend analysis, or the frequency of occurrence of extreme, or otherwise critical, values are evaluated, so that there can be a warning in time before stoppage of the measuring field-device.

A basic idea of the invention is to register, besides the process variables registered by the measuring field-device, also other variables, which have an influence on service life and ability of the measuring field-device to function. In such case, these influencing variables can be won by sensors arranged on, or in, the measuring field-device. They can, however, also be won in the environment by separated sensors or even by other measuring field-devices, to the extent that they are supplied, for example via a common bus, to the measuring field-device, in which the method of the invention for determining its state is performed.

The following variables can, for example, be registered as influencing variables of the above-mentioned kind:
the temperature on the outside, or in the interior, of the measuring field-device, or the temperature of a probe of the measuring field-device;
the moisture level inside the housing of the measuring field-device;
a vibration of the measuring field-device;
a force acting on the measuring field-device or on one of its parts, especially in the case of measuring field-devices having a probe or waveguide connected with the measuring field-device;
a pressure, especially a pressure inside the housing of the measuring field-device;
a concentration of undesired gases in the housing of the measuring field-device, especially gases from the process, or aggressive gases.

Moreover, service life or ability of the measuring field-device to function is determined by switching-on processes, by voltage transients on lines connected with the measuring field-device, or by the number of electrostatic discharges on the measuring field-device, its housing or a probe or operating unit connected with the measuring field-device. Also these influencing variables are taken into consideration in a special form of embodiment of the invention in the determining of expected service life or ability of the measuring field-device to continue functioning.

The importance of determining these influencing variables can be illustrated on the basis of simple examples. It is known that, in the case of some measuring field-devices, the accuracy of their transducer or sensor lies outside of the specified range above a certain temperature. An additional temperature measurement can, therefore, assure the functional ability. Beyond this, the strength of many materials used as housing materials, seals, adhesives or solder for measuring field-devices decreases with increasing temperature. This means that, at high temperatures, already a smaller applied force than at low temperatures can lead to a failure of components. It is, therefore, sensible, and, with the invention, possible, to register temperature and e.g. vibration, at an electronics circuit board in the measuring field-device, in order to predict a possible crack formation at solder locations and, in such manner, to warn, in time, before the stoppage of the entire measuring field-device.

Especially critical is the situation where aggressive gases penetrate from a process into a measuring device housing and decompose plastic parts, or corrode metal parts. However, also the escape of such gases into the environment through a measuring field-device is not desired. If the conditions are right, infiltrated gases can also lead to an explosion of the measuring field-device. Therefore, it makes sense to detect infiltrated gas, for example using a pressure sensor. Then, an appropriate safety measure can be introduced, before the device fails.

Moisture inside measuring field-devices can represent a problem from many points of view:
it can lead to corrosion of sensitive components, for instance plug connectors;
it can lead to leakage currents or even short circuiting on electrical conductors;
it can lead to function disturbances due to the capacitance of films of moisture; and
it can lead to a fogging of viewing windows, for instance in the case of display instruments.

Most often, damaged seals and an insufficient protection against rain, water spray, etc. lead to penetration of moisture. If penetration of moisture is a problem to be faced in the measuring field-device and if electronic components in the field device cannot be protected from moisture by other suitable measures, for instance potting, then moisture in the measuring field-device must be monitored, for example by means of a dew sensor, in order to warn in time, before a stoppage of the measuring field-device.

Also vibrations influence service life and ability of measuring field-devices to function, since they can lead to component fractures due to material fatigue. Vibrations should, therefore, be monitored, for example by acceleration sensors.

Forces act especially on medium-contacting probes of measuring field-devices, when the probes, which are used, for example, for measuring fill level of a medium, are in contact with the medium. Flowing liquids exert transverse forces on rigid probes, while bulk goods can also exert tensile forces on probes. The registering of such forces should be used, then, to prevent overloading of the probe, or of its location of securement on the container, by timely stopping of the filling, in the case of bulk goods, or of a stirrer, in the case of liquids.

The registered tensile force can, in the right circumstances, be, however, not only of concern for diagnosis of the measuring field-device; it can also be of concern for other reasons. For instance, if a silo roof is less capable of taking a load than the probe of the measuring field-device secured on the silo roof, then a tensile force measurement can be used to protect the silo roof from collapse.

It has been found that additionally registered, influencing variables can themselves serve for the determining of process variables. Thus, for instance, a force effect measured on a rope probe of an appropriately equipped measuring field-device, as the probe extends into a process medium, can also be used as a measure for the fill level of the process medium.

The invention will now be described and explained in greater detail on the basis of examples of different, preferred forms of embodiment, with reference to the appended drawings, the figures of which show as follows:

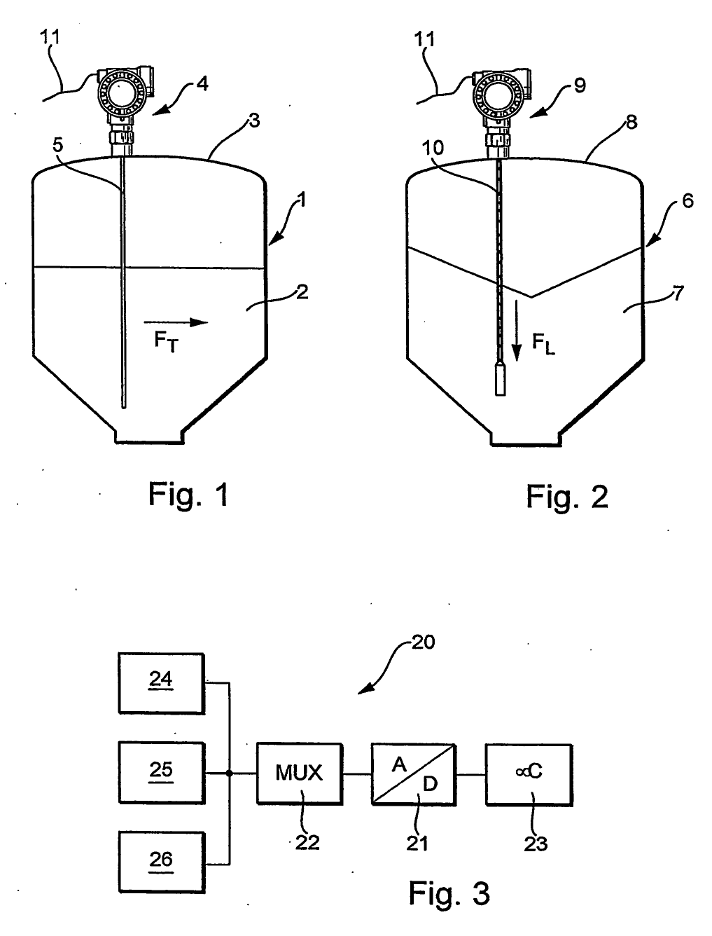

FIG. 1 a schematic representation of a measuring field-device for measuring the fill level of a liquid;

FIG. 2 a schematic representation of a measuring field-device for measuring the fill level of a bulk good;

FIG. 3 a schematic presentation of a block diagram of an evaluating circuit in a measuring field-device of the invention;

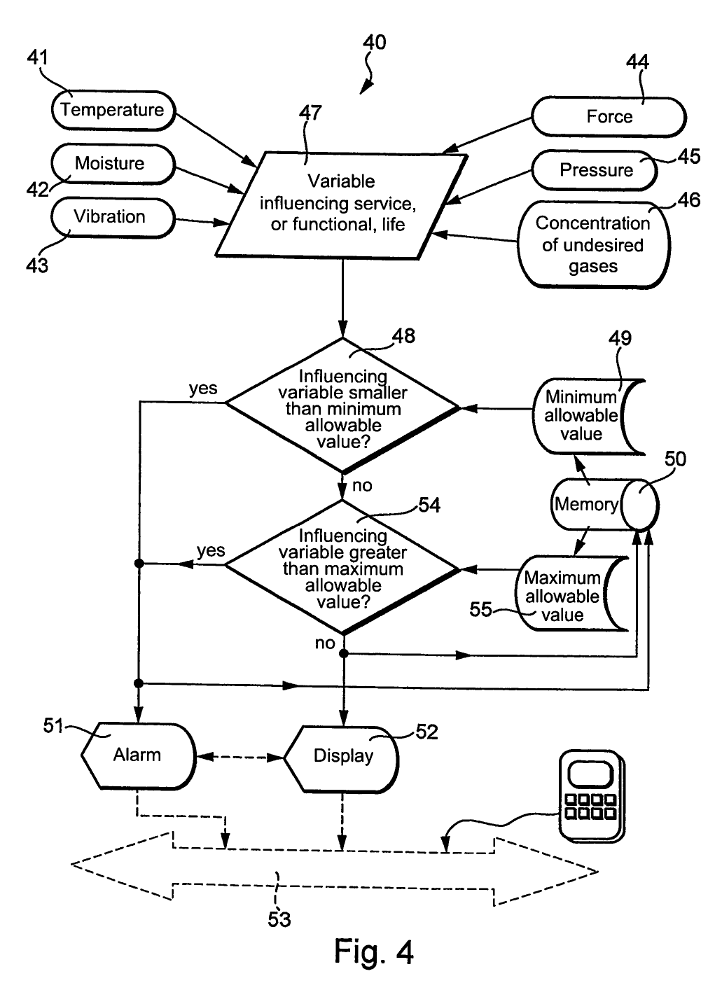

FIG. 4 a schematic flow diagram of a first preferred form of embodiment of the method of the invention;

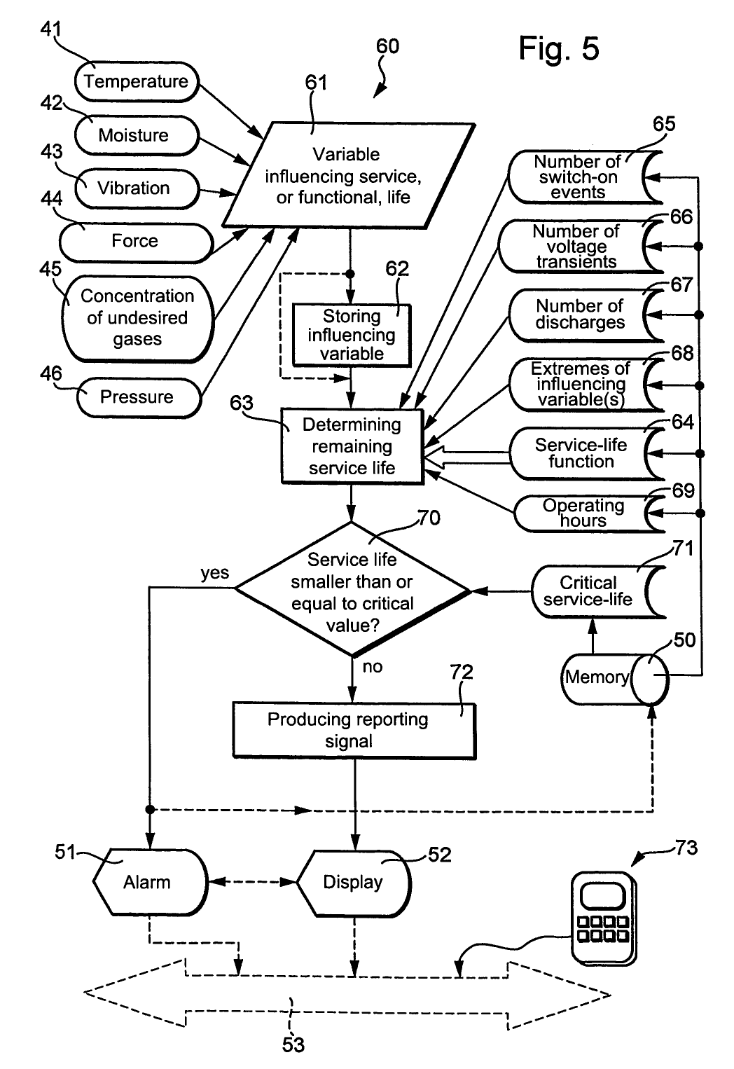

FIG. 5 a schematic flow diagram of a second preferred form of embodiment of the method of the invention;

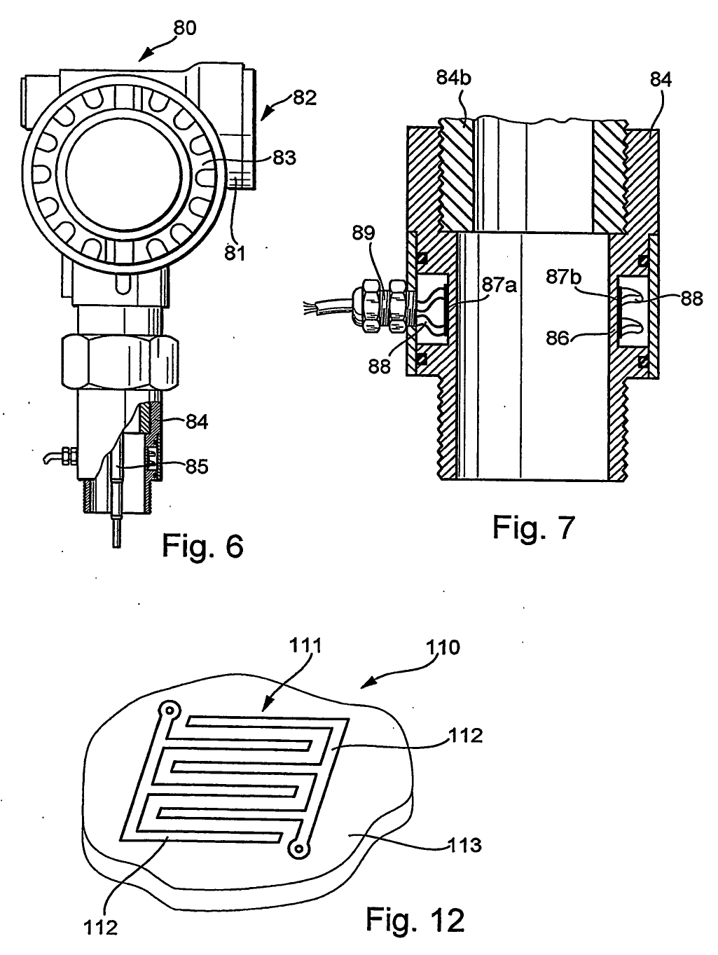

FIG. 6 a perspective representation of a preferred form of embodiment of a measuring field-device of the invention, in side view;

FIG. 7 a sectional, enlarged view of a detail of the measuring field-device of FIG. 6;

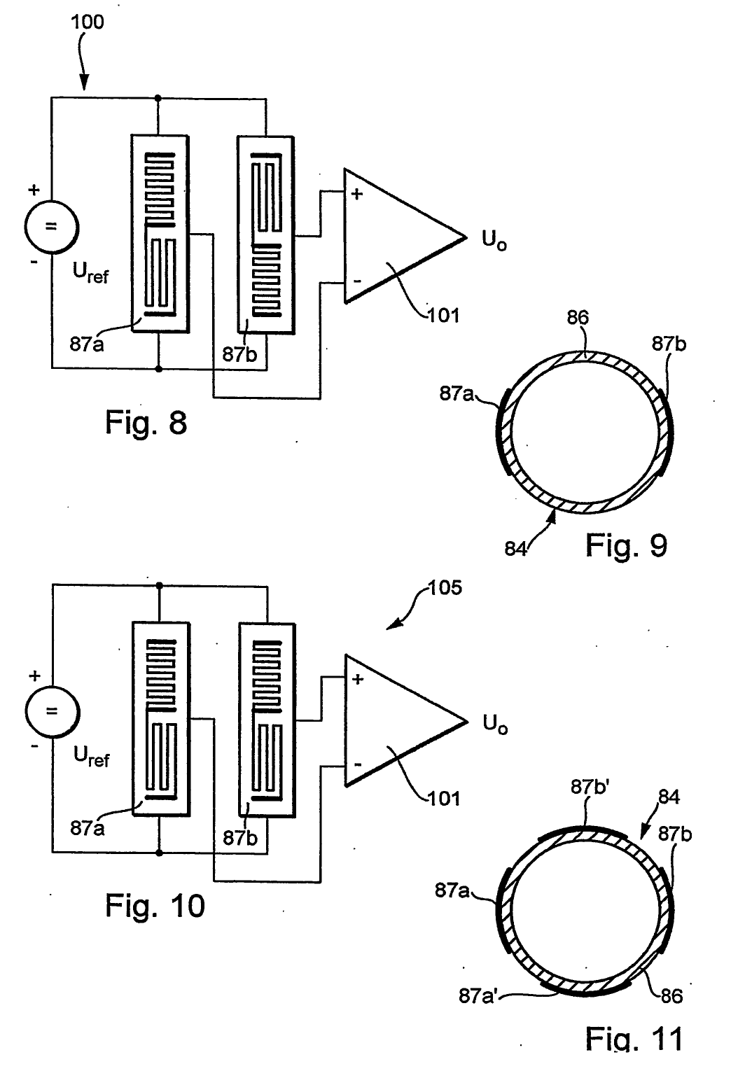

FIG. 8 a schematic presentation of an operating circuit of a transducer of the invention for registering a tensile force;

FIG. 9 a sectional view of a detail of the form of embodiment of a measuring field-device with applied transducer of FIG. 8;

FIG. 10 a schematic presentation of a block diagram for a transducer of the invention for registering a transverse force;

FIG. 11 a sectional view of a detail of the form of embodiment of a measuring field-device with applied transducer of FIG. 10; and

FIG. 12 a schematic representation of a dew sensor of the invention.

For simplification, equal parts in the drawings are provided with equal reference characters.

FIGS. 1 and 2 serve to illustrate the technical context of the invention. FIG. 1 shows a first container 1, which is filled with a liquid process medium 2. Mounted on a roof 3 of the first container is a first measuring field-device 4, with which the fill level of the process medium 2 is determined. The first measuring field-device 4 includes, for such propose, a probe 5 extending into the process medium 2. In the example illustrated here, probe 5 is a rigid probe. In the case in which the first measuring field-device 4 is a capacitive measuring field-device, probe 5 is an electrode. And, in the case where the first measuring field-device 4 is a fill level measuring device working with guided microwave signals, probe 5 is a waveguide.

FIG. 2 shows a second container 6, which is, in the example illustrated here, filled with a bulk good as process medium 7. Mounted on a roof 8 of the second container 6 is a second measuring field-device 9, with which the fill level of the bulk good 7 is determined. The second measuring field-device 9 includes, for this purpose, a probe 10 extending into the bulk good 7. In the example illustrated here, probe 10 is a rope probe. Usually, in the case of this second measuring field-device 9, such is a fill level measuring device working with guided microwave signals, with the rope probe 10 being a waveguide. Both measuring field-devices 4, 9 are, as illustrated in FIGS. 1 and 2, usually connected with a measurements control room or to a bus connected with the control room. Corresponding connecting cable 11 illustrates this in FIGS. 1 and 2.

To simplify and unclutter the drawings, both containers 1 and 6 of FIGS. 1 and 2 are shown without inlets and outlets for the process media 2 and 7. For the second container 6 in FIG. 2, an outlet is, however, assumed in the lower region of container 6, as is evident from the upper surface of the bulk good 7.

As already mentioned above, the pertinent process medium 2, 7 exerts forces on the probes 5, 10; these forces influence service life or functional ability. In the first container 1, when the process medium is moving, as a result, for example, of a stirrer (not shown) installed in the container 7, transverse forces act on the rigid probe 5, these being illustrated in FIG. 1 by an arrow and the reference character F_{T}. In the second container 6, tensile forces caused by the bulk good 7 act on the rope probe 10, these being illustrated in FIG. 2 by an arrow and the reference character F_{L}. Registering of these forces on the measuring field-devices 4 and 9, or on their probes 5 and 10, and the determining of the effects thereof on service life and ability of measuring field-devices to function, is a subject matter of the invention and is explained below.

The block diagram of FIG. 3 represents an example of an evaluation circuit for performing the method of the invention for determining the state of a measuring field-device, as such is implementable in the measuring field-device itself. A basic principle, in such case, is that, besides registering a measured value 24 for a process variable, which is the fill level in the case of the measuring field-devices 4 and 9 illustrated in FIGS. 1 and 2, other variables 25 and 26 are registered, using appropriate sensors mounted on, or in, the measuring field-devices, which other variables 25 and 26 have an influence on the service life, or ability of the considered measuring field-device to function. By way of illustration, only two influencing variables 25 and 26 are shown here. However, there can be still more (see, in this connection, also FIGS. 4 and 5), which can be considered for the estimating of probable service life and ability of the considered measuring field-device to function.

Preferably, the influencing variables 25 and 26 are conditioned in analog fashion in suitable operating circuits, preparatory to their then being converted to digital form with the same A/D-converter 21 also used to convert the measurement signal A for the process variable. A multiplexer 22 permits selection of the desired input signal, which is then processed further with the help of a microprocessor 23. Microprocessor 23 is especially suited to perform linearizing and scaling of the measurement signals, to store extreme values and averages, and, as required, to store information retrievably. It can, moreover, also serve, in cooperation with a suitable memory in the measuring field device, to store the time of day when unallowable conditions existed for registering the combined effect of the various influencing variables and for calculating a remaining, probable service life. In case critical values arise for the registered influencing variables 25, 26, the microprocessor 23 can issue an alarm signal. The methods of the invention described below on the basis of FIGS. 4 and 5 can be performed in a measuring field-device of FIG. 3.

FIG. 4 illustrates a preferred form of embodiment of a first method 40 of the invention for determining the state of a measuring field-device, which is equipped, according to the invention, with at least one, but, preferably however, with a plurality of appropriate sensors for registering influencing variables influencing service life and ability of the measuring field-device to function.

At least one of the registered influencing variables, e.g. temperature, moisture, vibration, force, pressure, concentration of undesired gases in the measuring device housing of the measuring field-device, is registered by a suitable sensor, or transducer, 41, 42, 43, 44, 45, 46 and is the input variable 47 of the method 40.

The registering of temperature by means of a temperature sensor 41 on, or in, the measuring device housing, or on a probe of a measuring field-device equipped therewith, represents the registering of an important influencing variable as regards service life and ability of the measuring field-device to function. For example, measuring field-device transducers exist, in the case of which the accuracy lies outside of the specified range, when temperature is above a certain level. In order to know, as of when the measuring field-device is no longer working reliably, it can be necessary to monitor temperature of the process, the environment and/or on, or in, the device. Moreover, the strength of many materials serving, for instance, as materials for the measuring device housing, for the transducer for registering the process variables, for a probe and/or other module, or components of the measuring field-device, depends on temperature.

A temperature measurement can be performed using sufficiently known methods. Especially suitable for such methods are resistive temperature sensors 41, such as, for example, platinum resistors, semiconductor resistors, etc., or thermoelements. Operating circuits for such sensors are described, for instance, in U. Tietze, Ch. Schenk: Halbleiter-Schaltungstechnik, 9. Auflage (Semiconductor Circuit Technology, 9th Edition), Springer-Verlag, Berlin, 1989, at pages 889-907. Temperature measurement, perhaps with a plurality of sensors 41, is done where temperature-sensitive components are located; thus, on an electronics circuit board in the measuring device housing, or where, due to the usual conditions of use, an excessively high temperature is to be expected earliest, for example at a process flange of a measuring field-device extending into a hot process medium.

Also moisture is an important influencing variable for service life and ability of the measuring field-device to function. Thus, damaged or older seals and an insufficient protection against rain, water spray, etc., frequently lead to infiltration of moisture into the measuring device housing. If the electronic components of the electronics circuit boards located there can not be protected against moisture by other suitable measures, such as potting, then the moisture 42 in the measuring device housing should be monitored, preferably by means of humidity, or dew, sensors 42. Humidity sensors 42 possess the advantage that they can continuously measure relative humidity, even when no dew has yet formed. A dew sensor first responds when dew has formed, but has the advantage that it is significantly cheaper.

Especially suited for humidity sensor 42 are commercialy available, capacitive sensors (e.g. type MiniCap 2 of the firm Panametrics GmbH, D-65719 Hofheim, Germany). Operating circuits for such sensors are described in U. Tietze, Ch. Schenk: Halbleiter-Schaltungstechnik, 9. Auflage, (Semiconductor Circuit Technology, 9th Edition), Springer-Verlag, Berlin, 1989, pages 922-925.

Suited as dew sensors are resistive or capacitive sensors. Especially recommending itself is a capacitive dew sensor implemented by an interdigital structure of conductive traces provided directly on an electronics circuit board already present anyway. Since, in any event, electronics circuit boards react especially sensitively to dew formation, this allows measuring right at the most sensitive location, with, then, only minimal extra costs arising. Such a dew sensor of the invention with an interdigital structure of conductive traces will be explained in yet more detail below, on the basis of the example illustrated in FIG. 12.

Vibration, which is another important influencing variable as regards service life and ability of the measuring field-device to function, leads frequently to component fractures caused by material fatigue. Vibration can be monitored by acceleration sensors 43. Previously used sensors with strain gages on a weighted membrane are used less frequently today; one is more apt to use, in contrast, micromechanical sensors now. An example of such an acceleration sensor 43 is the type ADXL 202 of the firm Analog Devices. Since vibration often leads to failure only after the part has been subjected to such for a long time, it is best to monitor the influences and effects of the vibration continuously and to register, via a microprocessor, the cumulative action of vibration and temperature.

Forces act also on medium-contacting probes in the case of measuring field-devices which are so equipped, especially, for example, in the case of those used for fill level measurement. Flowing liquids exert transverse forces on rigid probes (see FIG. 1). Bulk goods (see FIG. 2) can exert tensile forces on probes. Force is an important influencing variable on service life and ability of the measuring field-device to function. An overloading of the probe, or of a point of securement of the measuring field-device on the container, can be prevented, for example, by timely stopping of the filling, in the case of bulk goods, or of the stirrer, in the case of liquids.

It is expedient to determine force on a probe by means of strain gages 44, which, according to the invention, are preferably adhered on two sides of an adapter, in the case of a rope probe. Such a form of embodiment of the invention will be explained and described below in connection with FIGS. 6 to 11.

For a measuring of tensile force, the strain gages 44, which are embodied in the form of two half-bridges, are preferably so connected that both a thermal expansion and a bending alone do not lead to an output signal. Should, in contrast, the transverse force need to be measured, then it makes more sense to use four half-bridges, which are so connected pairwise that, in each case, the transverse force in two mutually perpendicular directions can be measured with one pair. Of course, the strain gages 44 can also be arranged inside of the measuring device housing.

Instead of strain gages, also simpler methods of force measurement can be used. For example, a spring element can be so arranged that it gives a certain deflection at a certain force, and the deflection can be determined with an inductive or capacitive proximity switch or by actuation of a mechanical switch, for example a magnetically actuated, reed relay.

Still another important influencing variable for service life and functional ability is the content of undesired gas in the measuring device housing. Especially critical is the situation in which aggressive gases penetrate from a process into the measuring device housing and, there, decompose plastic parts or corrode metal parts. But, also, escape of such gases into the environment through a measuring device is as a rule undesired. Under the right circumstances, infiltrated gases can also lead to an explosion of the device. Various sensors and methods are suitable for detecting infiltrated gases.

One option for determining whether undesired gases have penetrated into the measuring device housing is to register the pressure in the measuring device housing by means of a pressure sensor 45, in the case where the gas of concern can infiltrate under pressure from a container and then bring-about a pressure increase in the measuring device housing. For the pressure measurement, known methods are suitable, especially the detection of deformation of a membrane via strain gages. Operating circuits for such sensors 45 are described, for example, in U. Tietze, Ch. Schenk: Halbleiter-Schaltungstechnik, 9. Auglage (Semiconductor Circuit Technology, 9th Edition), Springer-Verlag, Berlin, 1989, at pages 908-920.

Besides measurement of pressure with a pressure sensor 45, the sensor 46 for registering a concentration of undesired gases in the measuring device housing can also be a ceramic resistor, whose resistance value varies with adsorption of the gas to be detected. Another kind of sensor 46 for determining gas concentration is a MOSFET, whose threshold voltage changes with adsorption of the gas to be detected, under the gate. Yet another variant of a gas sensor is represented by a sensor 46, in which an absorption of electromagnetic waves, especially in the infrared, is used for the specific detection of individual gases. Suited as light sources are laser diodes, e.g. lead-salt diodes, which have become available for various wavelengths, or thermal radiators, which, as required, with calcium fluoride window, radiate light up to 9 μm wavelength. The excitement of oscillations of many molecules lies in this range (see, in this connection, e.g. H. Haken, H. C. Wolf: Molekulphysik und Quantenchemie (Molecule Physics and Quantum Chemistry), Springer-Verlag, Berlin, 1991, pages 153-178).

The concentration of undesired gases inside the measuring device housing can also be determined by means of a sensor 46, in which a sound velocity is determined, for example in the ultrasonic range, is monitored in the measuring device housing, and is compared with a previously determined eigenfrequency of a chamber in the measuring device housing. The sound velocity varies for different gases in the range of some hundred meters per second up to more than 1000 meters per second (see e.g. Bergmann-Schaefer, Lehrbuch der Experimentalphysik, Band I, 9. Auflage (Textbook of Experimental Physics, Vol. I, 9th Edition), Verlag Walter de Gruyter & Co., Berlin, 1974, pages 492-493), so that sound velocity can also be used for determining infiltrated, undesired gases.

As already mentioned above and illustrated in FIG. 4, at least one of the registered influencing variables temperature, moisture, vibration, force effect, pressure, concentration of undesired gases in the measuring device housing of the measuring field-device, is registered by a suitable sensor, or transducer, 41, 42, 43, 44, 45, 46 and serves as input variable 47 of the method 40. This influencing variable 47 is subjected to a comparison 48 with a minimum allowable value 49 for the influencing variable under consideration. The minimum allowable value 49 is preferably stored in a memory 50 in the measuring field-device and is read-out for the comparison 48 with the currently registered, influencing variable 47. If the currently registered influencing variable 47 is smaller than the minimum allowable value 49, then an alarm signal 51 is produced, which is, for example, issued directly as an acoustic, or optical, signal. The simplest implementations of suitable signals are, for example, a siren and a blink light integrated in the measuring field-device or mounted externally thereon. The alarm signal 51 can, however, also be indicated on the display 52 of the measuring field-device. If desired, it is also possible in simple manner to issue an appropriate alarm signal onto a bus 53. The alarm signal 51 can then be transmitted e.g. to a control room.

If the currently registered, influencing variable 47 is greater than the minimum allowable value 49, then it is subjected to a comparison 54 with a maximum allowable value 55 for the influencing variable under consideration. The maximum allowable value 55 is stored preferably in memory 50 in the measuring field-device and is read-out for the comparison 54 with the currently registered influencing variable 47. If it turns out, from the comparison 54, that the currently registered, influencing variable 47 is larger than the maximum allowable value 55, then, likewise, the alarm signal 51 is produced, which can be a signal corresponding to the above-described alarm signal, or another. Also this alarm signal can be used either directly as an acoustic, or optical, signal and issued via the above-described siren or blink light. The alarm signal 51 can, however, also be indicated on the display 52 of the measuring field-device and/or, in case desired, placed on bus 53. If the currently registered, influencing variable 47 is smaller than the maximum allowable value 55, then it is output on the display 52 of the measuring field-device. In case a later evaluation of registered influencing variables 47 and/or of produced alarm signals 51 is desired, the, in each case, generated alarm signals 51 and the influencing variables 47 can, along with the associated dates and points in time, be stored in memory 50.

FIG. 5 illustrates a preferred form of embodiment of a second method 60 of the invention for determining the state of a measuring field-device equipped, according to the invention, with at least one, preferably, however, with a plurality of, sensors for the registering of influencing variables influencing the service life or ability of the measuring field-device to function.

As in the case of the first method 40 of the invention, as already illustrated in, and described above with reference to, FIG. 4, also in the case of the second method 60, at least one of the influencing variables temperature, moisture, vibration, force, pressure, concentration of undesired gases in the measuring device housing of the measuring field-device, as registered by a suitable sensor, or transducer, 41, 42, 43, 44, 45, 46, is the input variable 61 of the second method 60. The significance of the individual influencing variables, their registering, and suitable sensors therefor, were explained and described in detail above.

Preferably, the current influencing variable 61 is stored, in order that it can be supplied for further evaluations. The storing 62 is, however, not mandatory. It can also be done later in the method 60. The influencing variable 61, or the influencing variables, in case a plurality is used, is/are preferably either as such or else together with the respective points in time and dates when they were registered, stored in memory 50 of the measuring field-device (see, in this connection, also FIG. 4).

Next, a determining 63 of remaining, probable service life and functional ability of the measuring field-device under consideration is performed. Basis for the determining 63 is a predetermined, mathematical, functional relationship between the registered influencing variables and the service life of the measuring field-device. The service life is, in such case, not only a function of various influencing variables, but also a function of time; preferably also taken into consideration is the combined influence of plural influencing variables. This service-life function 64, which is preferably stored in memory 50 of the measuring field-device, is determined by experiment or simulation by variation of the different influencing variables, as a consequence of which the expected, remaining service life can then be calculated. As an example, let us take the case of a vibratory limit-switch, which works with a piezoelectrically excited tuning fork, which fractures after a certain number of vibrations, due to material fatigue. This number n is given, by way of example, by a linear function of temperature T as follows:
n(T)=a−bT,
where a and b are positive numbers. In order, in the case of operating at changing temperatures, to obtain a prognosis concerning service life, temperature must, therefore, be registered. The remaining service life can then be calculated in the above example approximately on the basis of (a−bTₘ)/f, where Tm is the average temperature over the history of use, to this point in time, and f is the oscillation frequency of the tuning fork.

Another example of the dependence of service life and functional ability was already described above. The strength of many materials decreases with increasing temperature. It therefore makes sense to register, under controlled conditions, the functional relationship between temperature, vibration and service life for the electronics circuit board used for the measuring field device under consideration. With this predetermined service life function, it then becomes possible, according to the second method of the invention illustrated in FIG. 5, in connection with the registration of temperature and vibration, to predict a possible cracking at solder locations of the electronics circuit board under consideration. Further examples of the influences on service life and functional ability of the measuring field-device under consideration, or parts or modules thereof, were already given above.

Expediently for the determining of probable service life and functional ability, not only influencing variables registered by the additional sensors 41-46 are considered, but also influencing variables, which are of statistical nature or even calculated. Such influencing variables, which, like the ‘measured’ influencing variables, can be very determinative for service life and functional ability of the measuring field-device under consideration, are illustrated by way of example in FIG. 5. They are expediently stored in memory 50. Of concern here are the number 65 of switch-on events up to the point in time under consideration, the number 66 of voltage transients on the lines 11 of the measuring field-device (see, in this connection, FIGS. 1 and 2), the number 67 of electrostatic discharges, recorded extreme values 68 of ‘measured’ influencing variables, and the number 69 of operating hours accumulated to the point in time under consideration.

Following the determining 63 of the probable service life of the measuring field-device, the determined service life is subjected to a comparison 70 with a predetermined, critical service life value 71 read out of memory 50. Such a critical service life value 71 can be, for example, a predetermined period of time, which is required, in order to procure a replacement device. From a practical point of view, that means that, when e.g. usually two weeks are needed from an ordering until delivery, installation and adjustment of a replacement device, it makes sense to set a critical service life value of at least these two weeks, in order that, in the case of an actual failure of the monitored measuring field-device, a replacement is ready to operate in time. It is clear that the critical service life value 71 does not need to be for the entire measuring field-device. It can also be set for individual, special components, modules or parts of the measuring field-device, especially then, when these components, modules or parts are determinative for the ability of the measuring field-device to function. Especially seals against the process and, naturally, the electronics in the measuring device housing are critical parts of the measuring field-device.

If it is found from the comparison 70 that the determined service life 63 is smaller than or equal to the critical value 71, then, again, the acoustic or optical alarm signal 51 known from the first method 40 is produced and issued at the measuring field-device (see, in this connection, FIG. 4). Equally, if required, the alarm signal 51 can be displayed on the display 52 of the correspondingly equipped, measuring field-device, or output on the bus 53 connected therewith.

If the determined, probable service life 63 is greater than the critical service life 71, then a report signal 72 is produced, which gives information concerning the probable, remaining service life of the measuring field-device, or its parts, components, or modules. Such a report signal 72 can be, for example, the percent remaining service life, or the remaining service life in months, weeks and days. However, also information on the period of time until the next probable replacement of a component is another option. The report signal 72 is displayed on the display 52 of the measuring field-device and preferably placed on the bus 53 connected with the measuring field-device, so that it can be received in a control room connected with the bus 53 and appropriately processed.

All signals, whether alarm signal 51 or report signal 72, placed on bus 52, can be received and output by another device attached to the bus, to the extent that this other device is appropriately setup for such. This makes sense, for example, in the case of a so-called hand-held device 73, such as is common in process measurement technology and such as is schematically indicated in FIG. 5.

FIGS. 6 and 7 illustrate a preferred form of a measuring field-device 80 of the invention. In the case of the measuring field-device 80 illustrated here, registered as influencing variable influencing the service life or ability of the measuring field-device to function is the force exerted on its probe 85 during operation. Arranged around rope probe 85 is, in the example of an embodiment illustrated here, an adapter 84, which enables measurement of the tensile force on the rope probe. Expediently, the force exerted on rope probe 85 is, as illustrated in FIG. 7, determined with strain gages 87a, 87b. A force acting on the rope probe 85 acts also on its seating 84b, and, since this is screwed tight in the adapter 84 against a shoulder there, also on adapter 84, where it can be registered.

FIG. 7 shows an enlarged view of a longitudinal section through adapter 84. In the example illustrated here, adapter 84 is a tubular, metal part with strain gages 87a and 87b adhered on two sides. In order to obtain the desired resolution, the wall thickness of adapter 84 is preferably lessened in a region 86, where the gages 87a and 87b are mounted. For protecting the mounted gages 87a and 87b against moisture, a sleeve 90 is pushed over the adapter 84. Sleeve 90 is resiliently sealed by O-rings, as shown in FIG. 7. Adapter 84 can be screwed into a threaded process connection. Serving for electrical contacting of the gages 87a and 87b are the lines of a connecting cable 88, which leaves adapter 84 through a cable feedthrough 89.

An example of an embodiment for an electrical circuit 100 of the strain gages 87a and 87b and their layout is shown in FIG. 8 for the registering of a tensile force acting on the rope probe 85 (see, in this connection, FIGS. 6 and 2). The direction in which the tensile force is acting is shown by arrow F_{L} in FIG. 2. For measuring the tensile force, the strain gages 87a and 87b are so connected as half-bridges, that both their thermal expansion and a bending lead to no output signal. Suitable as amplifier 101 are especially so-called ‘instrumentation amplifiers’, for example the types INA 102 or XTR 106 of Burr-Brown. The symmetrical arrangement of the gages 87a and 87b in the region 86 of the adapter 84 (see, in this connection, also FIGS. 6 and 7) is shown in FIG. 9, in the form of a cross section through the adapter 84. For the sake of emphasizing the relationship of interest, rope probe 85 is not shown in FIG. 9.

If, in contrast, a transverse force F_{T} acting on the probe 5 is to be registered (see, in this connection, also FIG. 1), then four half-bridge strain gages are expediently applied for such purpose. These are so connected in pairs that, in each case with one pair, the transverse force can be measured in two mutually perpendicular directions. An example of a circuit 105 for one such pair of gages 87a and 87b is shown in FIG. 10. The mechanical arrangement together with another pair of gages 87a′ and 87b′ likewise connected as in FIG. 10 is shown in FIG. 11 in the region 86 of the adapter 84 (see, in this connection, also FIGS. 6 and 7), in the form of a cross section through the adapter 84.

Interestingly, the tensile force on the rope probe, registered as influencing variable on the service life of the measuring field-device, can also be used additionally for determining a fill level of the medium in the container. Consequently, in the case of bulk goods, the direct measurement of the fill level with a capacitive or TDR sensor can be checked on the basis of the tensile force. The tensile force increases with increasing fill level, density of the fill substance, coefficient of friction between probe and fill substance, probe diameter, silo, or container, diameter, as the case may be, and the horizontal load ratio of the fill substance, and sinks with the coefficient of friction between fill substance and container wall. It can, therefore, be calculated for each fill level using the disk-element method of Janssen (see P. Martens (publisher): Silo-Handbuch (Silo Handbook), Ernst & Sohn Verlag, Berlin) and stored in the device, for example as a calibration curve.

In the case of liquids in open troughs, the force effect on the probe can also be used to determine the flow velocity. This, together with the value of the fill level, permits calculation of a volume flow rate. Therefore, it is not necessary, in the case of fill level measurement in open troughs, to install a nozzle to back-up the liquid. One needs only one fill level measuring device for flow measurement, instead of two. In the case of not-too-high viscosity and not-too-low flow velocity v, a turbulent flow is established around a rod probe of diameter d, with the moment on the probe caused by the transverse force being given by
M=0.45ρ V² d L (L_{N}-0.5 L),
where ρ stands for density, L for fill level and L_{N} for probe length. From this formula, the flow velocity can then be easily calculated. Alternatively, the vibration frequency of the probe rod transversely to the flow direction can be measured. Since, behind the rod, vortices are alternately released, left and right, the rod is excited to execute oscillations, whose frequency is proportional to the flow velocity.

Of course, strain gages can also be placed inside the measuring field-device. Instead of strain gages, simpler methods of force measurement are available options.

As already described above, damaged seals and an insufficient protection against rain, water spray, etc. lead to infiltration of moisture into the measuring device housing of the measuring field-device, which can have a detrimental effect on probable service life and ability of the measuring field-device to function. In critical situations, moisture inside the measuring device housing should, therefore, be monitored and registered as an influencing variable. Suitable for such purpose are humidity, or dew, sensors. A dew sensor does, it is true, only respond once dew has formed, but its cost is considerably less and it can be a simple resistive or capacitive sensor. FIG. 12 shows a dew sensor 110 for a measuring field-device of the invention. This form of dew sensor is relatively simple and cost-effective to implement, since, as a capacitive dew sensor with an interdigital structure 111 of conductive traces 112, it is etched directly on an electronics circuit board, which is to be accommodated in the measuring device housing and which, thus, is to be present anyway. As a result, minimal incremental costs are experienced, while, at the same time, electronics circuit boards react especially sensitively to dew formation, so that the most sensitive location is being measured.

1-55. (canceled)

56. A method for determining the state of a measuring field-device for process automation and process measurement technology for registering at least one process variable of a process medium, comprising the steps of:
registering at least one influencing variable influencing expected service life, or ability of the measuring field-device to function, wherein the influencing variable is not the process variable;
comparing the measured influencing variable, or a variable derived therefrom, with a predetermined maximum, or minimum, allowable value for this influencing variable or the derived variable; and
generating and issuing an alarm signal in the case of exceeding of the maximum allowable value, or in the case of subceeding, or falling beneath, the minimum allowable value, of the influencing variable or the derived variable.

57. A method for determining the state of a measuring field-device for process automation and process measurement technology for registering at least one process variable of a process medium, comprising the steps of:
registering at least one influencing variable influencing expected service life of the measuring field-device, wherein the influencing variable is not the process variable;
determining probable service life of the measuring field-device, or remaining period of time until the reaching of a point in time for maintenance work, by means of a predetermined function and on the basis of the currently registered influencing variable; and
producing and issuing a report signal, which corresponds to the probable service life of the measuring field-device or the remaining period of time until the reaching of a point in time for maintenance work.

58. The method as claimed in claim 56, wherein:
the alarm signal is issued by an alarm, or display, apparatus on, or in, the measuring field-device.

59. The method as claimed in claim 56, wherein:
the alarm signal is issued by a corresponding apparatus from the measuring field-device onto a bus.

60. The method as claimed in claim 56, wherein:
the alarm signal is retrievable by an apparatus connectable to the measuring field-device.

61. The method as claimed in claim 57, wherein:
the reporting signal is issued by a display apparatus on, or in, the measuring field-device.

62. The method as claimed in claim 57, wherein:
the reporting signal is issued by an apparatus from the measuring field-device onto a bus.

63. The method as claimed in claim 57, wherein:
the reporting signal is retrievable by an apparatus connectable to the measuring field-device.

64. The method as claimed in claim 56, wherein:
the registered influencing variable influencing expected service life or the ability of the measuring field-device to function is a physical variable.

65. The method as claimed in claim 56, wherein:
the registered influencing variable influencing expected service life or the ability of the measuring field-device to function is a calculated variable.

66. The method as claimed in claim 56, wherein:
the registered influencing variable influencing expected service life or the ability of the measuring field-device to function is a statistical variable.

67. The method as claimed in claim 56, wherein:
the registered influencing variable influencing expected service life or the ability of the measuring field-device to function is temperature.

68. The method as claimed in claim 56, wherein:
the registered influencing variable influencing expected service life or the ability of the measuring field-device to function is moisture.

69. The method as claimed in claim 56, wherein:
the registered influencing variable influencing expected service life or the ability of the measuring field-device to function is a vibration.

70. The method as claimed in claim 56, wherein:
the registered influencing variable influencing expected service life or the ability of the measuring field-device to function is a force.

71. The method as claimed in claim 56, wherein:
the registered influencing variable influencing expected service life or the ability of the measuring field-device to function is a pressure inside a measuring device housing of the measuring field-device.

72. The method as claimed in claim 56, wherein:
the registered influencing variable influencing expected service life or the ability of the measuring field-device to function is a concentration of undesired gases in the measuring device housing.

73. The method as claimed in claim 56, wherein:
the registered influencing variable influencing expected service life or the ability of the measuring field-device to function is the number of switch-on events of the measuring field-device.

74. The method as claimed in claim 56, wherein:
the registered influencing variable influencing expected service life or the ability of the measuring field-device to function is the number of voltage transients on lines connected with the measuring field-device.

75. The method as claimed in claim 56, wherein:
the registered influencing variable influencing expected service life or the ability of the measuring field-device to function is the number of electrostatic discharges on the measuring field-device, its housing, or a probe or operating unit connected with the measuring field-device.

76. The method as claimed in claim 56, wherein:
different influencing variables influencing expected service life or the ability of the measuring field-device to function are registered.

77. The method as claimed in claim 56, wherein:
the influencing variable, or influencing variables, influencing expected service life or the ability of the measuring field-device to function are stored.

78. The method as claimed in claim 76, wherein:
a plurality of currently registered influencing variables are considered for determining probable service life or the ability of the measuring field-device to function.

79. The method as claimed in claim 77, wherein:
at least one currently registered, and at least one stored, influencing variable are considered for determining probable service life or ability of the measuring field-device to function.

80. The method as claimed in claim 56, wherein:
the frequency of the alarm signals in a certain period of time is considered for determining probable service life or ability of the measuring field-device to function.

81. The method as claimed in claim 77, wherein:
extreme values of the current and stored influencing variables and/or their frequency in a certain period of time are considered for determining probable service life or ability of the measuring field-device to function.

82. The method as claimed in claim 78, wherein:
the stored influencing variables are subjected to a trend analysis and that a remaining period of time until the reaching of a predetermined, probable service life of the measuring field-device is determined and output for determining probable service life or ability of the measuring field-device to function.

83. The method as claimed in claim 57, wherein:
the issued reporting signal contains information concerning a remaining period of time until the reaching of a point in time for maintenance work on a module or component of the measuring field-device or for a predicted replacement of the module or component.

84. A measuring field-device for process automation and process measurement technology and for registering at least one process variable of a process medium, comprising:
a measuring device housing with electronics accommodated therein;
a mechanism for registering an influencing variable influencing expected service life, or the ability of the measuring field-device, or a part, or module thereof, to function, wherein the influencing variable is not the process variable;
a mechanism for comparing the measured influencing variable, or a variable derived therefrom, with a predetermined maximum, or minimum, allowable value for this influencing variable or the derived variable; and
a mechanism for generating and issuing an alarm signal in the case of exceeding the maximum allowable value, or in the case of subceeding, or falling beneath, the minimum allowable value, of the influencing variable or the derived variable.

85. A measuring field device for process automation and process measurement technology and for registering at least one process variable of a process medium, comprising:
a measuring device housing with electronics accommodated therein;
a mechanism for registering an influencing variable influencing expected service life, or ability of the measuring field-device, or a part, or module thereof, to function, wherein the influencing variable is not the process variable;
a mechanism for determining, by means of a predetermined function and on the basis of the currently registered influencing variable, probable service life, or remaining period of time until the reaching of a point in time for maintenance work on the measuring field-device, or a part, or module thereof; and
a mechanism for generating and issuing a reporting signal corresponding to the probable service life, or the remaining period of time until the reaching of a point in time for maintenance work on the measuring field-device, or a part, or module thereof.

86. The measuring field device as claimed in claim 84, wherein:
an alarm or display apparatus provided thereon or therein issues the alarm signal.

87. The measuring field device as claimed in claim 84, wherein:
the alarm signal is issued onto a bus connected to the measuring field-device.

88. The measuring field device as claimed in claim 84, further comprising:
an apparatus, to which an external apparatus is connectable, by means of which the alarm signal can be retrieved.

89. The measuring field device as claimed in claim 85, further comprising:
a display apparatus thereon or therein which issues the reporting signal.

90. The measuring field device as claimed in claim 85, wherein:
said mechanism for generating and issuing a reporting signal issues the reporting signal onto a bus connected to the measuring field-device.

91. The measuring field device as claimed in claim 85, further comprising:
an apparatus, to which an external apparatus is connectable, by means of which the reporting signal can be retrieved.

92. The measuring field device as claimed in claim 84, further comprising:
at least one additional sensor or transducer for registering a physical variable, which is the influencing variable influencing the expected service life or ability of the measuring field-device to function.

93. The measuring field device as claimed in claim 84, wherein:
the influencing variable influencing the expected service life, or the ability of the measuring field-device to function, is calculated.

94. The measuring field-device as claimed in claim 92, wherein:
said additional sensor or transducer registers a temperature.

95. The measuring field-device as claimed in claim 92, wherein:
said additional sensor or transducer registers a moisture.

96. The measuring field-device as claimed in claim 92, wherein:
said additional sensor or transducer registers a vibration.

97. The measuring field-device as claimed in claim 92, wherein:
said additional sensor or transducer registers a force.

98. The measuring field-device as claimed in claim 92, wherein:
said additional sensor or transducer registers a pressure inside the measuring device housing of the measuring field-device.

99. The measuring field-device as claimed in claim 92, wherein:
said additional sensor or transducer registers a concentration of undesired gases in the measuring device housing.

100. The measuring field-device as claimed in claim 84, wherein;
said mechanism for registering registers the number of switch-on events of the measuring field-device and takes such into consideration as an influencing variable on expected service life or the ability of the measuring field-device to function.

101. The measuring field-device as claimed in claim 84, wherein:
said mechanism for registering registers voltage transients on lines electrically connected with it and takes such into consideration as an influencing variable on expected service life or the ability of the measuring field-device to function.

102. The measuring field-device as claimed in claim 84, wherein:
said mechanism for registering registers electrostatic discharges on the measuring field device, its housing or a probe or operating unit connected with it and takes such into consideration as an influencing variable on expected service life or the functional ability.

103. The measuring field-device as claimed in claim 92, wherein:
different influencing variables influencing expected service life, or the ability of the measuring field-device to function, are registered.

104. The measuring field-device as claimed in claim 84, wherein:
said mechanism for registering includes a memory, wherein a currently registered influencing variable, or variables, influencing expected service life, or ability of the measuring field-device to function, is/are stored.

105. The measuring field-device as claimed in claim 103, wherein:
a plurality of currently registered influencing variables are considered for determining probable service life or ability of the measuring field-device to function.

106. The measuring field device as claimed in claim 104, wherein:
at least one currently registered, and at least one stored, influencing variable are considered for determining probable service life or ability of the measuring field-device to function.

107. The measuring field-device as claimed in claim 84, wherein:
the frequency of alarm signals within a certain period of time period are considered for determining probable service life or ability of the measuring field-device to function.

108. The measuring field-device as claimed in claim 104, wherein:
extreme values of current and/or stored, influencing variables and/or their frequency within a certain period of time are considered for determining probable service life or ability of the measuring field-device to function.

109. Measuring field-device as claimed in claim 104, wherein:
for determining probable service life or ability of the measuring field-device to function, stored influencing variables are subjected to a trend analysis and a remaining period of time until the reaching of a predetermined probable service life of the measuring field-device is determined and output.

110. Measuring field-device as claimed in claim 85, wherein:
the issued reporting signal contains information concerning a remaining period of time until the reaching of a point in time for maintenance work on a module or component of the measuring field-device or concerning a probable replacement of the module or component.
